(19) United States
(12) Patent Application Publication
(10) Pub. No.: US 2025/0346253 A1
(43) Pub. Date: Nov. 13, 2025

(54) DEVICE AND COMPUTER-IMPLEMENTED METHOD FOR DETERMINING TRAJECTORIES FOR A VEHICLE

(71) Applicant: Robert Bosch GmbH, Stuttgart (DE)

(72) Inventors: Andreas Schmidt, Stuttgart (DE); Johannes Christian Mueller, Stuttgart (DE); Maxim Dolgov, Renningen (DE); Ralf Kohlhaas, Calw (DE); Steffen Waeldele, Renningen (DE)

(21) Appl. No.: 19/188,477

(22) Filed: Apr. 24, 2025

(30) Foreign Application Priority Data
May 7, 2024 (DE) 10 2024 204 242.0

(51) Int. Cl. B60W 60/00; G06N 3/08

(52) U.S. Cl. CPC B60W 60/0011; B60W 60/0015; G06N 3/08

(57) ABSTRACT

A device and a computer-implemented method for determining trajectories for a vehicle. An environment model is provided, the environment model containing environment information about the vehicle surrounding area. At least one behavior is provided. A first trajectory for the vehicle is planned using an artificial neural network based on the environment information, or a trajectory for the vehicle is planned using a rule-based model based on the behavior. The trajectory is selected and/or changed using a rule-based model based on the environment information and the trajectory and depending on the behavior and depending on costs.

### CROSS REFERENCE

The present application claims the benefit under 35 U.S.C. § 119 of German Patent Application No. DE 10 2024 204 242.0 filed on May 7, 2025, which is expressly incorporated herein by reference in its entirety.

### FIELD

The present invention relates to a device and a computer-implemented method for determining trajectories for a vehicle.

### BACKGROUND INFORMATION

C. Hubschneider et al. (2017): “Integrating end-to-end learned steering into probabilistic autonomous driving” describes a method for determining vehicle trajectories on the basis of video data. This method combines deep learning and conventional approaches for determining trajectories using factor graph methodology.

### SUMMARY

The device and the computer-implemented method of the present invention for determining trajectories for a vehicle represent an alternative for determining trajectories that does not require factor graph methodology and also makes it possible to provide safety guarantees for trajectories.

According to an example embodiment of the present invention, the computer-implemented method for determining trajectories for a vehicle provides that
an environment model is provided, the environment model containing environment information about the vehicle surrounding area,
at least one behavior is provided,
a trajectory for the vehicle is planned using an artificial neural network on the basis of the environment information, or
a trajectory for the vehicle is planned using a rule-based model on the basis of the behavior,
the trajectory is selected and/or changed using a rule-based model on the basis the environment information and the trajectory and depending on the behavior and depending on costs.

The rule-based model is a model that comprises
physical laws,
rules such as, e.g., traffic rules,
heuristics, e.g., regarding what is considered comfortable driving,
parameters, e.g. vehicle parameters.

The parameters can also be learned parameters or can be learned. The second trajectory is created in the rule-based model, e.g., by an optimization algorithm. Examples of the control algorithm are Hybrid A* or MPC. The rule-based model has the advantage of being understandable for humans. The rule-based model serves the safety objectives, but also optimizes the performance of the second trajectory.

According to an example embodiment of the present invention, the neural network may have learned implicit quality requirements for particularly comfortable/human-like driving. This can be carried out, for example, using an imitation learning approach. For this purpose, a data set is used for training which contains the current situation, e.g. in the form of an environment model on the one hand and the trajectory driven by a human driver on the other hand.

By using the rule-based model and the neural network, rule-based modeled trajectories and learned trajectories are modeled. This means that both explicitly describable and implicitly learnable aspects are considered together.

For example, it is provided that
a plurality of behaviors with different priorities is specified,
a trajectory is determined and/or changed for each behavior.

For example, it is provided that
a list of a plurality of prioritized behaviors is specified,
a trajectory is determined and/or changed for each behavior,
the trajectory associated with the highest-priority behavior in the list is selected as the trajectory for the vehicle.

The costs are determined, for example, depending on the environment information and/or depending on the behavior.

According to an example embodiment of the present invention, a portion of the costs is modeled, for example, using a machine learning model that is trained to allocate respective costs depending on the environment information and/or depending on the behavior.

According to an example embodiment of the present invention, a portion of the costs is modeled, for example, using a rule-based model that is designed to allocate respective costs depending on the environment information and/or depending on the behavior.

It can be provided that the behavior is selected from a plurality of specified behaviors depending on the costs.

According to an example embodiment of the present invention, it can be provided that the vehicle carries out contingency planning, at least one safety objective and at least one objective characterizing a performance of the trajectory being specified, the trajectory being planned on a first time horizon that achieves the objective characterizing the performance as well as possible and that fulfills the at least one safety objective in the first time horizon, a continuation of the trajectory planned on the first time horizon being planned on a second time horizon that is longer than the first time horizon, which trajectory may achieve the objective characterizing the performance less well than the trajectory planned on the first time horizon, the rule-based model being used to determine a changed trajectory as the trajectory for the vehicle until the end of the second time horizon on the basis of the environment information and the trajectory planned for the second time horizon and depending on the behavior and depending on costs before the end of the first time horizon, or the trajectory planned on the second time horizon being determined as a changed trajectory for the vehicle until the end of the second time horizon, if no changed trajectory is determined as a trajectory for the vehicle until the end of the second time horizon by the end of the first period. The continuation can be a multimodal continuation. For example, the continuation can be planned with the aid of the Hybrid A* algorithm. In the example, the continuation is not executed initially but is replanned through a re-planning process. However, the continuation guarantees that there will still be a solution with acceptable performance at the end of the short-term planning horizon, i.e. the first time horizon. This is an advantage.

By continuing the trajectory in a rule-based manner through the changed trajectory, i.e., taking replanning into account, the vehicle typically follows a particularly high-performance trajectory. There are no strict requirements regarding the necessary planning horizon. If the trajectory is determined by the neural network, the continuation ensures that the planning problem can be solved even beyond the planning horizon of the network.

For example, it is provided that
the environment information comprises information about the vehicle surrounding area at a first point in time,
a plurality of trajectories for the vehicle is determined depending on the information about the vehicle surrounding area at the first point in time,
the vehicle is moved on the first trajectory,
while the vehicle is moved on the first trajectory, environment information is determined which comprises information about the vehicle surrounding area at a second point in time,
the second trajectory is determined depending on the information about the vehicle surrounding area at the second point in time,
the vehicle is moved on the second trajectory instead of the first trajectory.

According to an example embodiment of the present invention, for training purposes, it can be provided that training data are provided which comprise reference trajectories for the trajectory of the vehicle, the reference trajectories simulating human driving behavior or representing detected human driving behavior, the artificial neural network being trained to determine trajectories for the vehicle which correspond as closely as possible to the reference trajectories.

A device, in particular a control unit, of the present invention for determining trajectories for a vehicle is designed to carry out the method of the present invention.

Further advantageous embodiments of the present invention can be found in the following description and the figures.

### BRIEF DESCRIPTION OF THE DRAWINGS

FIG. 1 is a schematic representation of a device for determining trajectories for a vehicle, according to an example embodiment of the present invention.

FIG. 2 is a schematic representation of an architecture for determining trajectories for the vehicle, according to an example embodiment of the present invention.

FIG. 3 is a flow chart with steps of a method for determining trajectories for the vehicle, according to an example embodiment of the present invention.

FIG. 4 shows an example of planning a trajectory for the vehicle, according to an example embodiment of the present invention.

### DETAILED DESCRIPTION OF EXAMPLE EMBODIMENTS

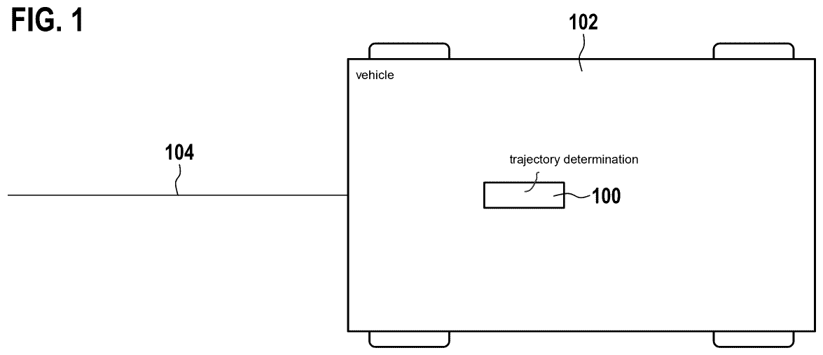

FIG. 1 schematically shows a device 100 for determining trajectories for a vehicle 102.

The device 100 is, e.g., a control unit of the vehicle 102.

In the example, the device 100 is designed to determine a trajectory 104 for the vehicle 102.

In the example, the device 100 is designed to move the vehicle 102 on the trajectory 104.

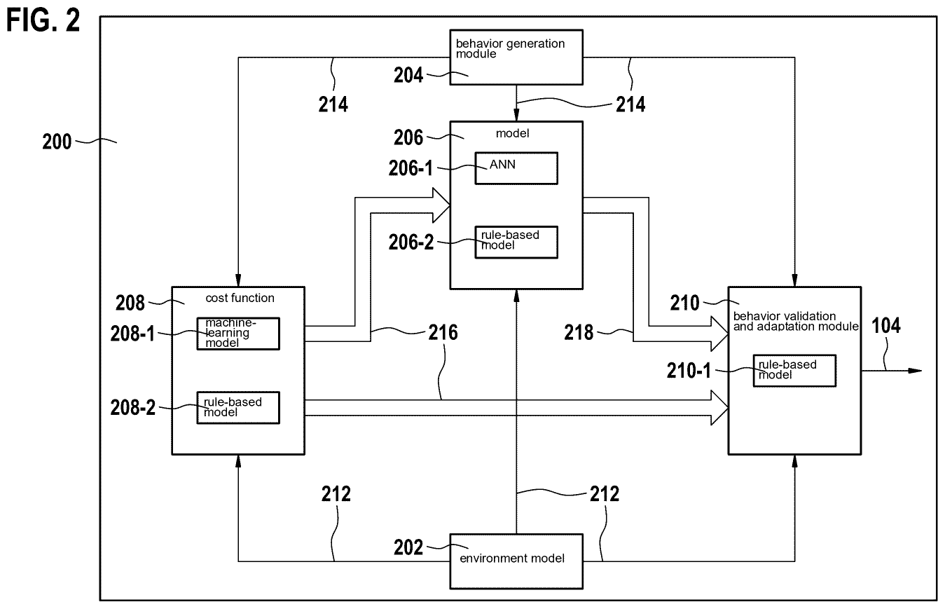

FIG. 2 schematically shows an architecture 200 for determining trajectories for the vehicle 102.

The architecture 200 comprises an environment model 202, a behavior generation module 204 for specifying at least one behavior, a model 206 for determining trajectories for the vehicle 102, a cost function 208, and a behavior validation and adaptation module 210.

The environment model 202 contains environment information about the vehicle surrounding area.

The behavior generation module 204 is designed to specify at least one behavior 214.

The behavior generation module 204 is designed, for example, to specify a boundary condition or boundary conditions as a behavior 214, or a list of prioritized behaviors. In this context, safe expansion means, for example, that the vehicle 102 can be moved safely when the vehicle 102 moves according to the behavior 214.

The cost function 208 is designed to specify costs 216 for a trajectory.

The cost function 208 comprises a machine learning model 208-1 designed to determine a portion of the costs 216 depending on the environment information 212 and/or depending on the at least one behavior 214. In the example, the machine learning model 208-1 is trained to determine the portion of the costs 216 depending on the environment information 212 and/or depending on the at least one behavior 214.

The machine learning model 208-1 for determining the portion of the costs 216 is designed to determine the portion of the costs on the basis of trajectories specified by the model 206 for determining trajectories.

The cost function 208 comprises a rule-based model 208-2 designed to determine another portion of the costs 216 depending on the environment information 212 and/or depending on the at least one behavior 214.

In the example, the cost function aggregates the portions of the costs.

An embodiment without the machine learning model 208-1 can be provided.

In one embodiment of the machine learning model 208-1, for example, a grid map for preferred regions and speeds is learned, which is then included in the costs 216 through appropriate weighting.

Another input variable for the machine learning model 208-1 can be a risk assessment of the surrounding area. Regions with potentially high risk, such as areas in front of pre-schools or areas that were particularly frequently occupied with difficult/complex situations in training data, can be marked in a grid map.

By taking risk into account in the costs 216, such regions are then preferably avoided.

The rule-based model 208-2 for determining the portion of the costs 216 is trained to determine the other portion of the costs on the basis of expert knowledge.

The rule-based model 208-2 can use grid maps that assign a specific cost value to each modeled state of the vehicle 102.

If the environment model 202 contains uncertainties regarding the estimated and possibly predicted states of other road users, these can also be included in the costs 216 by appropriate modeling with the rule-based model 208-2.

For example, probabilistic occupancy risks, which arise on the basis of the uncertainties of the environment model 202 and its prediction, are entered as costs in a grid map. The grid map comprises, e.g., cells. For example, different representations are selected for each cell and used for the probabilistic occupancy risks. For example, a pure occupancy probability or a more detailed and meaningful representation by means of subjective logic opinions is provided for each cell.

It can be provided that the grid map is spanned over a current state of the vehicle 102 and over a time window of the current state and the last N states of the vehicle 102. As a result, interaction with other vehicles can be mapped over a time horizon of N time steps. In particular, the costs 216 of future states can be conditioned on the last N time steps of the trajectory planned by the vehicle 102.

The cost function 208 allows for so-called contingency planning. Contingency planning means that an initial trajectory for the near future, which must meet specific safety requirements, is first generated. The initial trajectory is subsequently further planned for various eventualities in order to anticipate and achieve the most high-performance solution possible. Since the combinatorial complexity increases with each branching eventuality, it is necessary to perform a final state evaluation from a certain search depth. This final state evaluation can be carried out using the costs 216 from the cost function 208.

For generating an initial solution for subsequent contingency planning, a combination of trajectory planning with machine learning models and rule-based models can be used. With the rule-based models, e.g., a trajectory is determined taking into account the behaviors 214 previously selected depending on the costs 216. In this case, the restrictions of the individual selected behaviors 214 are considered combined, e.g., for a short period of time and subsequently considered separately in a subsequent period.

The model 206 for determining trajectories is designed to determine at least one trajectory 218.

The model 206 for determining trajectories comprises an artificial neural network 206-1, which is designed to plan a trajectory for the vehicle 102 on the basis of the environment information 212.

The artificial neural network 206-1 is trained to plan trajectories that are similar to the trajectories a human would plan on the basis of the environment information 212.

The model 206 for determining trajectories comprises a rule-based model 206-2 that is designed to plan a trajectory for the vehicle on the basis of the environment information 212 and the first trajectory depending on the behavior 214 and depending on the costs 216.

The rule-based model 206-2 for determining the trajectory is designed to determine the trajectory for the vehicle 102 in such a way that compliance with the specified behavior 214 is guaranteed.

In the example, a plurality of trajectories 218 is determined using the artificial neural network 206-1 and the rule-based model 206-2.

It can be provided that the model 206 for determining trajectories comprises either the artificial neural network 206-1 or the rule-based model 206-2.

The behavior validation and adaptation module 210 is designed to determine the trajectory 104. In the example, the behavior validation and adaptation module 210 comprises a rule-based model 210-1 for determining the trajectory 104 for the vehicle 102 depending on the at least one trajectory 218 and the costs 216.

The rule-based model 210-1 for determining the trajectory 104 for the vehicle 102 is designed to determine the trajectory 104 for the vehicle 102 in such a way that drivable behavior of the vehicle 102 is guaranteed.

The rule-based model 210-1 uses the Hybrid A* algorithm to generate trajectories, e.g. starting from an initial trajectory.

Accordingly, the initial trajectory is first converted to an initial solution in the search space of the Hybrid A* algorithm. This is carried out, e.g., by suitable sampling or by direct conversion of the support points of the initial trajectory 104. Possible trajectories are determined by locally optimizing the initial solution with the aid of the Hybrid A* algorithm. The initial solution and the local optimizations are defined by valid nodes in the search space of the Hybrid A* algorithm. Nodes are considered valid if they satisfy all the boundary conditions placed on them. These boundary conditions can, in particular, originate from the behaviors 214 generated by the behavior generation module 214.

If a node is invalid, the node is discarded during optimization. If the node representing the state of the vehicle 102 is also invalid, the behavior 214 from which the boundary conditions originate is discarded.

In local optimization, e.g., the cost function 208 is selected so that as many nodes from the initial solution as possible are used. For example, a state cost function, i.e. the costs for the respective nodes, is included in the cost function 208. However, the cost function 208 may have additional terms. For example, the cost function 208 can contain terms that favor the use of as many nodes from the initial solution as possible. The Hybrid A* algorithm, e.g., explores exclusively within the boundary conditions specified by the corresponding behavior 214. Accordingly, the solution of the optimization and thus ultimately the driving movement of the vehicle 102 on the trajectory thus determined inherits the safety guarantees defined by the boundary condition.

The optimization can also provide for the exploration of nodes that continue the initial solution into a different behavior that is currently anticipated but cannot currently be selected, e.g. due to a lack of visibility. In this way, a preferred behavior can be pre-controlled by locally optimizing the initial solution.

The rule-based models can be implemented on the basis of various optimization algorithms, such as, e.g. Hybrid A* Search, Rapidly Exploring Random Trees, or Monte Carlo Tree Search. The machine learning models can be trained using deep learning methods, such as, e.g., imitation learning, deep reinforcement learning or value function learning.

Proxy variables can be learned first, which are then incorporated into the state cost function using appropriate rule-based modeling. For example, a grid map of preferred regions (preferred region grid) and a grid map of preferred and/or maximum speeds are learned as proxy variables.

The device 100 is designed to carry out a method for determining trajectories.

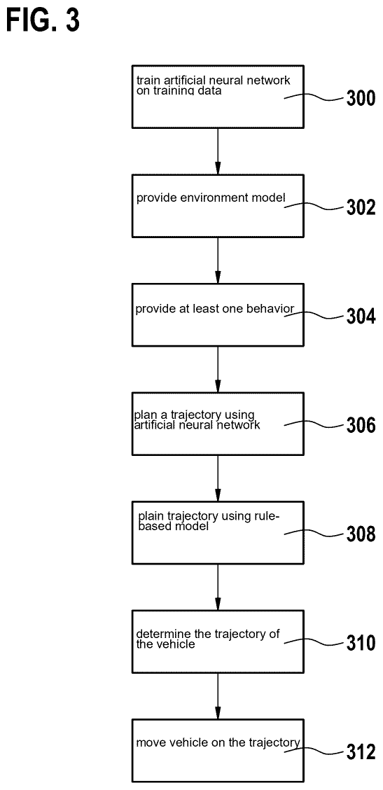

FIG. 3 shows a flow chart with steps of a method.

The method requires that environment information 202 is specified. How the environment information 202 is determined is not the subject of the method. In this regard, the following description of the environment information 202 is therefore exemplary. The method requires that at least one behavior 214 is specified. How the behavior 214 is determined is not the subject of the method. In this regard, the following description of the behavior 214 is therefore exemplary. The method requires that costs 216 are allocated. How the costs 216 are determined is not the subject of the method. In this regard, the following description of the costs 216 is therefore exemplary.

The method optionally comprises a step 300.

In optional step 300, the artificial neural network 206-1 is trained on training data to determine trajectories for the vehicle 102 that match reference trajectories from the training data as closely as possible.

For example, training data are provided, which comprise reference trajectories for the trajectory of the vehicle 102 that simulate human driving behavior.

For example, training data are provided, which comprise reference trajectories for the trajectory of the vehicle 102 that represent a detected human driving behavior. This allows for trajectories that generate a particularly human driving style of the vehicle 102.

It can be provided that the artificial neural network 206-1 is provided in a pre-trained state.

It can be provided that in step 300, the machine learning model 208-1 is trained.

For example, training data are provided, which comprise environment information 212 and/or behaviors 214 associated with the reference trajectories.

It can be provided that the machine learning model 208-1 is trained to allocate respective costs depending on environment information 212 and/or depending on behaviors 214 from the training data.

It can be provided that the machine learning model 208-1 is provided in a pre-trained state.

The method comprises a step 302.

In step 302, the environment model 202 is provided.

The environment model 202 contains environment information 212 about the vehicle surrounding area.

The method comprises a step 304.

In step 304, at least one behavior 214 is provided.

For example, a plurality of behaviors 214 with different priorities is specified.

It can be provided that a list of a plurality of prioritized behaviors 214 is specified.

The method optionally comprises a step 306.

In step 306, a trajectory is planned using the artificial neural network 206-1 on the basis of the environment information 212.

It can be provided that the trajectory is determined using the artificial neural network 206-1 on the basis of the behavior 214.

It can be provided that, if a plurality of behaviors 214 with different priorities is specified, a trajectory is determined for each behavior 214.

The method optionally comprises a step 308.

Step 306 and step 308 are optional insofar as the method comprises at least one of these steps.

In step 308, a trajectory for the vehicle 102 is planned using the rule-based model 206-2.

For example, the trajectory is planned using the rule-based model 206-2 depending on the behavior 214 and depending on costs 216.

In the example, the costs 216 are determined depending on the environment information 212 and/or depending on the behavior 214.

In the example, a portion of the costs is modeled using the machine learning model 208-1.

In the example, a portion of the costs is modeled using the rule-based model 208-2.

It can be provided that, if a plurality of behaviors 214 with different priorities is specified, a trajectory is determined for each behavior 214.

It can be provided that the behavior 214 for which the trajectory is determined is selected from the plurality of behaviors 214 depending on the costs 216.

In this context, planned means, for example, that the trajectory is selected from the trajectories determined for each behavior 214 using the rule-based model 206-2 on the basis of the environment information 212 and the trajectory itself and depending on the behavior 214 and depending on costs 216.

It can be provided that the trajectory is planned by changing a trajectory determined as described above using the rule-based model 210-1 on the basis of the environment information 212 and the trajectory itself and depending on the behavior 214 and depending on the costs 216.

It can be provided that the trajectory is not changed, but is only selected if no improved solution, i.e., trajectory, is found using the rule-based model 210-1 on the basis of the environment information 212 and the trajectory itself depending on the behavior 214 and depending on the costs 216. An example of an improved solution is a trajectory that has more favorable, e.g., lower, costs than another trajectory.

The method comprises a step 310.

In step 310, the trajectory 104 for the vehicle 102 is determined.

In the example, the trajectory 104 is determined using the rule-based model 210-1 for determining the trajectory 104 for the vehicle 102 in such a way that drivable behavior of the vehicle 102 is guaranteed.

In the example, the rule-based model 210-1 for determining the trajectory 104 for the vehicle is used to select and/or change the trajectory previously determined either with the artificial neural network 206-1 or the trajectory determined with the rule-based model 206-2. The selected or changed trajectory represents the trajectory 104 for the vehicle 102 determined using the rule-based model 210-1 for determining the trajectory 104.

It can be provided that the rule-based model 210-1 for determining the trajectory 104 selects and/or changes the trajectory determined using the rule-based model 206-2 on the basis of the environment information 212 depending on the trajectory planned by the artificial neural network 206-1 on the basis of the environment information 212.

There are several options for making changes. First, the trajectory can be locally optimized on the basis of costs 216. Local optimization is carried out, e.g., with the aid of an optimal control approach. Alternatively, a graph search such as, e.g., the Hybrid A* algorithm can be used.

Another possible change is the continuation of the trajectory. This change is particularly relevant if continuation is required by the boundary conditions of the behavior, but the artificial neural network 206-1 does not plan far enough due to the limited planning horizon. For the continuation, the continuation of the trajectory is determined, e.g., using the Hybrid A* algorithm.

For example, if the list of a plurality of prioritized behaviors 214 is specified, the changed trajectory of the changed trajectories determined for the respective behavior 214 is selected as the trajectory 104 for the vehicle 102 that is associated with the highest prioritized behavior in the list.

It can be provided that a changed trajectory is determined in parallel for each of the specified behaviors. It can be provided that the trajectory 104 is selected using the rule-based model 210-1 for determining the trajectory 104 for the vehicle, selecting the changed trajectory from the changed trajectories determined in parallel that best fits the specified safety objectives.

The selection of the trajectory is made by prioritizing the behaviors 214 according to the achievement of the safety objectives and selecting the trajectory that corresponds to the behavior 214 with the highest priority.

Safety objectives include
Compliance with traffic rules
Avoiding obstructions to other road users
Avoiding accidents.

It can be provided that the selected or changed trajectory is subsequently optimized again. Optimized means, for example, that a cost function, e.g., the costs 206, is defined depending on the trajectory. The cost function is minimized, e.g., in an optimization. This means that the selected or changed trajectory is used as the initial value in the optimization to find a trajectory that is optimal with respect to the selected or changed trajectory in terms of the cost function, which then replaces the selected or changed trajectory.

The method comprises a step 312.

In step 312, the vehicle 102 is moved on the trajectory 104 for the vehicle 102.

The method can provide that the trajectory 104 on which the vehicle 102 is moved is changed depending on the environment information 212.

For this purpose, environment information 212 is detected at a first point in time. The environment information 212 detected at the first point in time contains information about the vehicle surrounding area at the first point in time.

Subsequently, the method for determining trajectories is used to determine the trajectory on the basis of information about the vehicle surrounding area at the first time point.

Subsequently, at a second point in time, while the vehicle 102 is moving on the trajectory, new environment information 212 is determined. The new environment information 212 contains information about the vehicle surrounding area at the second point in time.

Subsequently, the method for determining trajectories is used to change the trajectory on the basis of information about the vehicle surrounding area at the second point in time.

Subsequently, the vehicle 102 is moved on the trajectory changed at the second point in time.

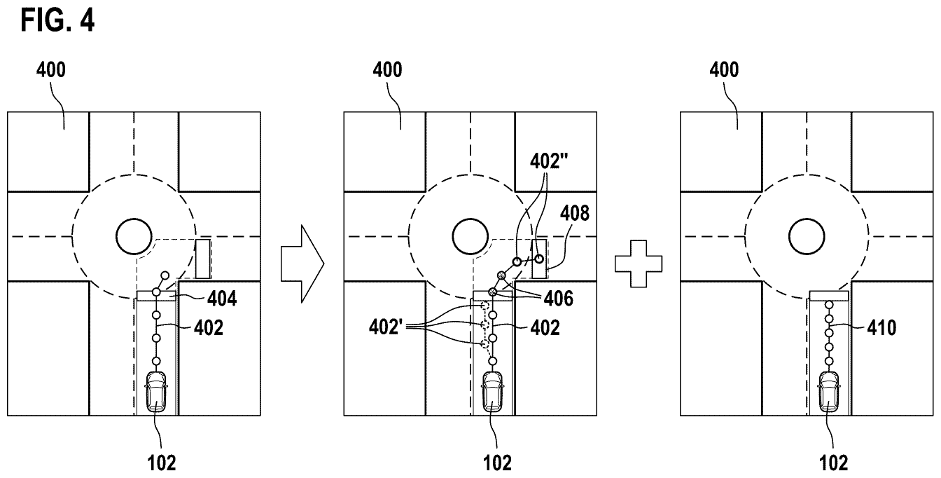

FIG. 4 shows an example of planning a trajectory for the vehicle 102. The trajectory is described in the example for driving around a roundabout 400.

First, an initial trajectory 402 is determined.

In the example, the initial trajectory 402 is determined using the artificial neural network 206-1. The initial trajectory in the example initially allows a particularly human driving style of the vehicle 102.

In the example, the learned human driving style results in the artificial neural network 206-1 learning that the view of the roundabout 400 improves as the vehicle 102 approaches the roundabout 400. The artificial neural network 206-1 anticipates, e.g., that entering the roundabout 400 will likely be possible. The initial trajectory 402 therefore extends beyond a stop line 404. In a situation with a lack of visibility of the entire roundabout, the artificial neural network 206-1 plans to enter the roundabout with the initial trajectory 402. In contrast, if visibility of the entire roundabout is insufficient, the rule-based model 206-2 would plan to stop at the stop line 404 before the roundabout.

According to the initial trajectory 402, the vehicle 102 is intended to move into the roundabout 400. The course of the initial trajectory 402 is shown in FIG. 4 as nodes connected by lines that lead into the roundabout 400. The initial trajectory 402 is checked in the example.

If the visibility of the vehicle 102 is not yet sufficient, corresponding nodes 406 are marked as invalid due to the boundary conditions.

Consequently, the Hybrid A* algorithm explores additional nodes 402′ in a local surrounding area that allow stopping.

In order to ensure that a new trajectory is found that leads to improved driving behavior, the Hybrid A* can additionally be configured to continue the initial trajectory 402 with node 402″ in such a way that, assuming sufficient visibility, the continuation would lead to a valid transit trajectory. The valid transit trajectory ends, e.g., when a target zone 408 is reached.

Overall, the example results in a new trajectory, the beginning of which is the initial solution that leads to a desired driving behavior and continues with a braking trajectory. The beginning of the braking trajectory found using the Hybrid A* algorithm is optimized to pre-control a transition to the anticipated and preferred transit behavior.

In addition to the possible new trajectory, the changed trajectory 410 is determined depending on the new trajectory.

According to the changed trajectory 410, the vehicle 102 is intended to stop at the stop line 404 before the roundabout 400. The course of the changed trajectory 410 is shown in FIG. 4 as nodes connected by lines that end before the roundabout 400.

It can be provided that the trajectories for the respective behaviors 214 are calculated in parallel. However, if this is not possible, e.g. due to the use of a single core embedded computing unit (ECU), trajectories can be determined, for example, on the basis of an analytical solution for the optimal trajectory. Such an analytical solution, e.g., makes certain assumptions about the state cost function as a heuristic. An example of an assumption is that the trajectory leads to the smallest possible longitudinal jerk of the vehicle 102 as a comfort criterion. This limits the quality of the solution in terms of comfort. However, the solution can be determined in a very short time, i.e. the safety guarantees can be significantly enhanced under limited computing resources.

What is claimed is:

1. A computer-implemented method for determining trajectories for a vehicle, the method comprising:
providing an environment model, the environment model containing environment information about a surrounding area of the vehicle;
providing at least one behavior;
(i) planning a trajectory for the vehicle using an artificial neural network based on the environment information, or (ii) planning a trajectory for the vehicle using a rule-based model based on the behavior; and
selecting or changing the trajectory using a rule-based model based on the environment information and the trajectory and depending on the behavior and depending on costs.

2. The method according to claim 1, wherein:
a plurality of behaviors with different priorities is specified, and
a trajectory is determined and/or changed for each behavior of the plurality of behaviors.

3. The method according to claim 1, wherein:
a list of a plurality of prioritized behaviors is specified,
a respective trajectory is determined and/or changed for each behavior of the plurality of prioritized behaviors, and
the respective trajectory associated with the highest-priority behavior in the list is selected as the trajectory for the vehicle.

4. The method according to claim 2, wherein the costs are determined depending on the environment information and/or depending on the behavior.

5. The method according to claim 1, wherein a portion of the costs is modeled using a machine learning model that is trained to allocate respective costs depending on the environment information and/or depending on the behavior.

6. The method according to claim 1, wherein a portion of the costs is modeled using a rule-based model that is configured to allocate respective costs depending on the environment information and/or depending on the behavior.

7. The method according to claim 1, wherein the behavior is selected from a plurality of specified behaviors depending on the cost.

8. The method according to claim 1, wherein at least one safety objective and at least one objective characterizing a performance of the trajectory are specified, the trajectory being planned on a first time horizon that achieves the objective characterizing the performance as well as possible and that fulfills the at least one safety objective in the first time horizon, a continuation of the trajectory planned on the first time horizon being planned on a second time horizon that is longer than the first time horizon, the continuation of the trajectory may achieve the objective characterizing the performance less well than the trajectory planned on the first time horizon, the rule-based model being used to determine a changed trajectory as the trajectory for the vehicle until the end of the second time horizon based on the environment information and the trajectory planned for the second time horizon and depending on the behavior and depending on costs before the end of the first time horizon, or the trajectory planned on the second time horizon being determined as a changed trajectory for the vehicle until an end of the second time horizon, when no changed trajectory is determined as a trajectory for the vehicle until the end of the second time horizon by an end of the first period.

9. The method according to claim 1, wherein:
the environment information includes information about the vehicle surrounding area at a first point in time,
a plurality of trajectories for the vehicle is determined depending on the information about the vehicle surrounding area at the first point in time,
the vehicle is moved on the trajectory,
while the vehicle is moved on the trajectory, environment information is determined that includes information about the vehicle surrounding area at a second point in time,
the trajectory is changed depending on the information about the vehicle surrounding area at the second point in time,
the vehicle is moved on the changed trajectory instead of on the trajectory.

10. The method according to claim 1, wherein training data are provided, which include reference trajectories for the trajectory of the vehicle, the reference trajectories simulating human driving behavior or representing detected human driving behavior, the artificial neural network being trained to determine trajectories for the vehicle that correspond as closely as possible to the reference trajectories.

11. A control device configured to determine trajectories for a vehicle, the device configured to:
provide an environment model, the environment model containing environment information about a surrounding area of the vehicle;
provide at least one behavior;
(i) plan a trajectory for the vehicle using an artificial neural network based on the environment information, or (ii) plan a trajectory for the vehicle using a rule-based model based on the behavior; and
select or change the trajectory using a rule-based model based on the environment information and the trajectory and depending on the behavior and depending on costs.
